(19) United States
(12) Patent Application Publication
(10) Pub. No.: US 2024/0290037 A1
(43) Pub. Date: Aug. 29, 2024

(54) METHODS, STORAGE MEDIA, AND SYSTEMS FOR INTEGRATING DATA STREAMS TO GENERATE VISUAL CUES

(71) Applicant: Hover Inc., San Francisco, CA (US)

(72) Inventors: Kerry Gould, San Francisco, CA (US); Jeffrey Sommers, San Francisco, CA (US); Harsh Barbhaiya, San Francisco, CA (US)

(73) Assignee: Hover Inc., San Francisco, CA (US)

(21) Appl. No.: 18/573,644

(22) PCT Filed: Jul. 7, 2022
(86) PCT No.: PCT/US2022/036415

§ 371 Date: Dec. 22, 2023

Related U.S. Application Data
(60) Provisional application No. 63/219,773, filed on Jul. 8, 2021.
(60) Provisional application No. 63/249,780, filed on Sep. 29, 2021.
(60) Provisional application No. 63/296,199, filed on Jan. 4, 2022.
(60) Provisional application No. 63/359,094, filed on Jul. 7, 2022.

(51) Int. Cl. G06T 17/20; G06T 5/70; G06T 15/00; G06T 15/80; G06T 19/20

(52) U.S. Cl. CPC G06T 17/20; G06T 5/70; G06T 15/005; G06T 15/80; G06T 19/20; G06T 2210/04; G06T 2210/32; G06T 2219/2012

(57) ABSTRACT

Methods, storage media, and systems for integrating disparate data streams of a current scan to generate visual cues of the current scan are disclosed. Exemplary implementations may: receive, from a data capture device, captured visual data and captured depth data of a current scan of an environment; generate a first plurality of masks based on the captured depth data; generate a depth propagation based on the first plurality of masks; generate augmented visual data based on the captured visual data, the first plurality of masks, and the depth propagation; and display, on a display of the data capture device, the augmented visual data.

### CROSS-REFERENCE TO RELATED APPLICATIONS

The present application is related to U.S. Provisional Application No. 63/219,773 filed on Jul. 8, 2021 entitled “MULTI-PASS PROCESSING PIPELINE”, U.S. Provisional Application No. 63/249,780 filed on Sep. 29, 2021 entitled “MULTI-PASS PROCESSING PIPELINE”, U.S. Provisional Application No. 63/296,199 filed on Jan. 4, 2021 entitled “MULTI-PASS PROCESSING PIPELINE”, and U.S. Provisional Application No. 63/359,094 filed on Jul. 7, 2022 entitled “METHODS, STORAGE MEDIA, AND SYSTEMS FOR INTEGRATING DATA STREAMS TO GENERATE VISUAL CUES”, which are hereby incorporated by reference in their entirety.

### BACKGROUND

### Field of the Invention

This disclosure generally relates to graphical processing pipelines.

### Description of Related Art

Computer vision techniques and capabilities continue to improve. A limiting factor in any computer vision pipeline is the input image itself. The input image can include visual data, depth data, or both. Low resolution images, blur, occlusion and subjects or portions thereof out of frame all limit the full scope of analyses that computer vision techniques provide. Providing real time feedback through an imaging system can direct improved capture of a given subject, thereby enabling enhanced use and output of a given captured image.

### BRIEF SUMMARY

Described herein are various methods generating and rendering viewfinder or display contents to provide feedback for data capture and to direct the data capture through adjustment of device parameters, such as position and orientation of a camera.

Though the field of scene analysis and reconstruction may broadly utilize the techniques described herein, specific discussion will be made using building structures such as, for example, commercial structures and residential structures, as the exemplary subject of data capture, and photogrammetry and digital reconstruction the illustrative use cases.

Though image analysis techniques can produce a vast amount of information, for example extracting elements such as points or lines, they are nonetheless limited by the quality of the data received. While modern imaging systems can deploy a plurality of sensors, the output of each sensor is not necessarily compatible with others. Incomplete data captures, or incompatibility between data streams underlying a single capture, may omit valuable information and preclude full exploitation of the data in the data capture. For example, a depth sensor such as LiDAR transmits and receives light information projected along a vector from the camera to the object, a z-axis, whereas visual data may be produced from a multitude of light sources independent of the camera positions and a display of such visual information disposed in an x-y plane orthogonal to a z-axis. Though information of one data stream may be directly applied to the other (e.g. a particular pixel appearing in the x-y display plane is assigned a depth value relative to the z-axis), inferences of one data stream are not inherently leveraged by such simple combination: a visual pixel (e.g. one with attributes expressed in RGB format) at a first distance does not necessarily appear different than it would at different distances.

Specific image processing techniques may require specific inputs. It is therefore desirable to prompt capture of a subject in a way that leverages the capabilities and modifies the output of one data stream relative to another sensor's data stream rather than rely on techniques in pre- or post-processing steps.

In some embodiments, a first data stream in a first format is subjected to a series of graphics passes to generate visual cues applicable to a second data format of a second data stream. For example, in some embodiments a visual data stream is augmented with a depth data stream to illustrate which portions visual data stream have been captured or occluded. In some embodiments described herein, a series of graphical passes is applied to a first data stream to correspond with display parameters of a second data stream. For example, depth data collected by a time of flight sensor is aggregated and at least one graphical pass is applied to generate visual cues overlaid on a visual data stream. In some embodiments, the visual cues inform a quality metric for the data capture, such as recency, occlusion potential, or position changes needed to complete the capture of the respective environment.

In three-dimensional (3D) modeling especially, data of a to-be-modeled subject can be of varying utility. For example, to construct a 3D representation of building structure, for example an interior of the building structure, data, such as visual data and depth data, of the building structure can be collected from various angles, such as from a smartphone, to capture various geometries and features of the building structure. A complete data capture is critical to understand how the visual data and depth data relates to one another and to reconstruct the subject in 3D space based on the data capture.

It is critical during data capture to maximize the amount of relevant data related to a subject for 3D reconstruction. Capturing as much content of the subject as possible during the data capture will maximize the opportunity for accurate 3D reconstruction.

Feedback resulting from integrating the various data streams can be displayed to the user via a viewfinder or display (hereinafter referred to simply as “display”), preferably concurrent with the camera's position and orientation. The feedback can be one or more masks applied to or overlaid on visual data.

One aspect of the present disclosure relates to a method for integrating disparate data streams of a current scan to generate visual cues of the current scan. The method may include receiving, from a data capture device, captured visual data and captured depth data of a current scan of an environment. The method may include generating a first plurality of masks based on the captured depth data. The method may include generating a depth propagation based on the first plurality of masks. The method may include generating augmented visual data based on the captured visual data, the first plurality of masks, and the depth propagation. The method may include displaying, on a display of the data capture device, the augmented visual data.

Another aspect of the present disclosure relates to a non-transient computer-readable storage medium having instructions embodied thereon, the instructions being executable by one or more processors to perform a method for integrating disparate data streams of a current scan to generate visual cues of the current scan. The method may include receiving, from a data capture device, captured visual data and captured depth data of a current scan of an environment. The method may include generating a first plurality of masks based on the captured depth data. The method may include generating a depth propagation based on the first plurality of masks. The method may include generating augmented visual data based on the captured visual data, the first plurality of masks, and the depth propagation. The method may include displaying, on a display of the data capture device, the augmented visual data.

Yet another aspect of the present disclosure relates to a system configured for integrating disparate data streams of a current scan to generate visual cues of the current scan. The system may include one or more hardware processors configured by machine-readable instructions. The processor(s) may be configured to receive, from a data capture device, captured visual data and captured depth data of a current scan of an environment. The processor(s) may be configured to generate a first plurality of masks based on the captured depth data. The processor(s) may be configured to generate a depth propagation based on the first plurality of masks. The processor(s) may be configured to generate augmented visual data based on the captured visual data, the first plurality of masks, and the depth propagation. The processor(s) may be configured to display, on a display of the data capture device, the augmented visual data.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

These and other embodiments, and the benefits they provide, are described more fully with reference to the figures and detailed description.

### BRIEF DESCRIPTION OF THE DRAWINGS

FIG. 1 illustrates a sample environment to be captured, according to some embodiments.

FIG. 2 illustrates a flow, according to some embodiments.

FIGS. 3A-3G illustrate profile views of a mesh surface, according to some embodiments.

FIG. 4 illustrates a render group, according to some embodiments.

FIGS. 5A-5B illustrate scanned environments with holes, according to some embodiments.

FIGS. 6A-6D illustrate depth histograms related to generated depth data, according to some embodiments.

FIG. 7 illustrates generated depth data, according to some embodiments.

FIGS. 8A-8C illustrate a top-down (x-y plane) view of a depth propagation over time, according to some embodiments.

FIGS. 9A-9C illustrate a side (y-z plane) view of a depth propagation over time, according to some embodiments.

FIGS. 10A-10F illustrate graphical user interface element views including a depth propagation over time, according to some embodiments.

FIG. 11 illustrates a block diagram of a computer system that may be used to implement the techniques described herein, according to some embodiments.

FIG. 12 illustrates a system configured for integrating disparate data streams of a current scan to generate visual cues of the current scan, according to some embodiments.

FIG. 13 illustrates a method for integrating disparate data streams of a current scan to generate visual cues of the current scan, according to some embodiments.

In the following description, for the purposes of explanation, numerous specific details are set forth in order to provide a thorough understanding of the present disclosure. It will be appreciated, however, that the present disclosure may be practiced without these specific details. In other instances, well-known structures and devices are shown in block diagram form in order to avoid unnecessarily obscuring the present disclosure. Like reference numbers and designations in the various drawing indicate like elements.

### DETAILED DESCRIPTION

### Data Capture Device

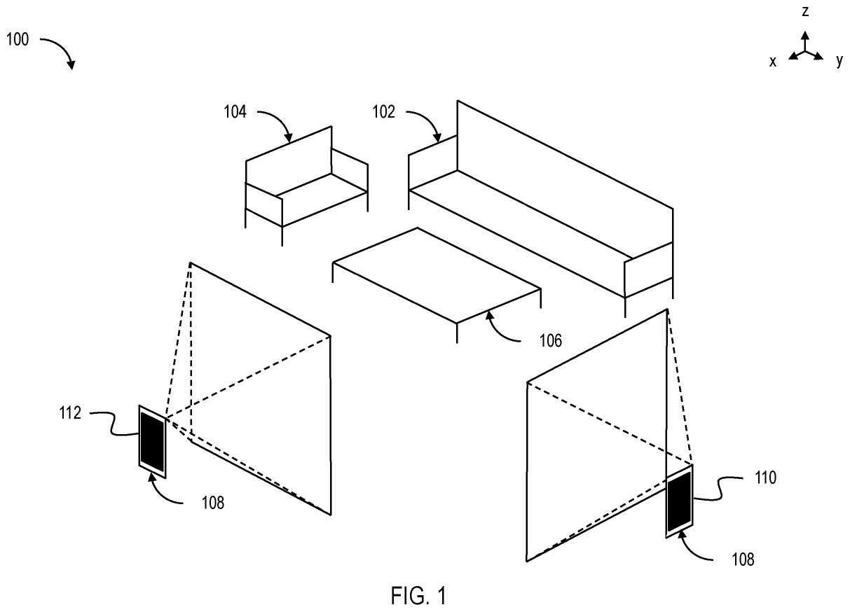

FIG. 1 illustrates a sample capture environment 100 to be captured, according to some embodiments. The environment 100 includes a sofa 102, a loveseat 104, and a coffee table 106. A data capture device 108, such as a smartphone or tablet computer, can capture data (sometimes referred to as “images” generally) such as image data (visual data, depth data, or both), process or augment data, and display data. Other examples of data capture devices 108 include drones, aircrafts (sometimes referred to as “aerial platform”), augmented reality (AR) headsets, virtual reality (VR) headsets, and the like. The data capture device 108 can have a pose, including position and orientation, such as a previous pose 110 (sometimes referred to as a “first pose 110”) and a current pose 112 (sometimes referred to as a “second pose 112”). In some embodiments, the pose can be included with or embedded in the data, for example as metadata.

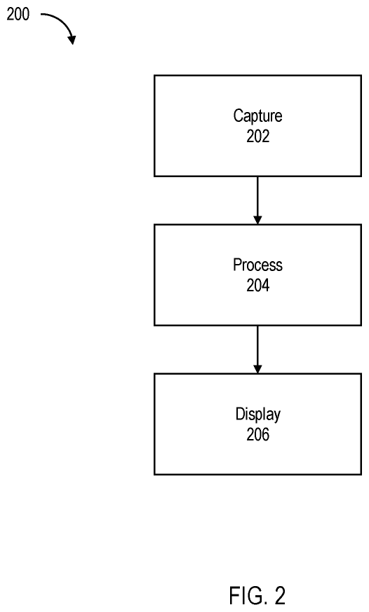

FIG. 2 illustrates a flow 200, according to some embodiments. The flow includes capturing (or receiving) 202, processing (or augmenting) 204, and displaying 206. In some embodiments, the data capture device 108 executes the flow 200. In some embodiments, the data capture device 108 and one or more devices external to the data capture device 108 (sometimes referred to as “external devices”) execute the flow 200.

The data capture device 108 captures 202 data of the environment 100. In some embodiments, the data is a set of sequential data. In some embodiments, the environment 100 can include an exterior of a building, an interior of a building (i.e., as illustrated in FIG. 1), or both. In these embodiments, the data can be of the exterior of the building, the interior of the building, or both, respectively. The data can include visual data (e.g., color information) and/or depth data (e.g., depth information). In some embodiments, the visual data can be captured as images or frames. In some embodiments, the images are a set of images including sequential images. The data capture device 108 can store the captured data in memory or in storage. In some embodiments, the data capture device 108 captures 202 data of the environment 100 as a part of a scan or capture session. In some embodiments, a scan or a capture session can include the data capture device 108 capturing 202 data of the environment 100 as the data capture device 108 moves (i.e., changes three-dimensional (3D) position) within the environment 100. In some examples, for example with reference to an exterior of a building, a scan or capture session can include the data capture device 108 capturing data of the exterior of the building as the data capture device 108 moves around the exterior of the building. In some examples, for example with reference to an interior of a building, a scan or capture session can include the data capture device 108 capturing data of the interior of the building as the data capture device 108 moves within the interior of the building. In some examples, for example with reference to an exterior of a building and an interior of the building, a scan or capture session can include the data capture device 108 capturing data of the exterior of the building as the data capture device 108 moves around the exterior of the building, capturing data of the interior of the building as the data capture device 108 moves within the interior of the building, and capturing data as the data capture device 108 transitions from the exterior of the building to the interior of the building, or vice versa. In some embodiments, the data capture device 108 receives or accesses the data of the environment 100. In these embodiments, the data capture device 108 can receive or access the data from memory or storage.

In some embodiments, a previous data captured by the data capture device 108 with the previous pose 110 can include the loveseat 104 and parts the coffee table 106, and a current data captured by the data capture device 108 with the current pose 112 can include the sofa 102 and parts of the coffee table 106.

The visual data can be from an image sensor, such as a charge coupled device (CCD) sensor or a complementary metal-oxide-semiconductor (CMOS) sensor, embedded within the data capture device 108. The visual data can include image data, video data, and the like.

The depth data can be from a depth sensor, such as a LiDAR sensor or a time-of-flight sensor, embedded within the data capture device 108. In some embodiments, the data capture device 108 can derive the depth data based on the visual data using one or more techniques such as, for example, structure-from-motion (SfM). The depth data can describe the distance to regions in the real world from a plane of the data capture device 108. The depth data can include 3D point clouds, 3D line clouds, 3D points, mesh anchors, mesh geometry, and the like. The mesh anchors are related to physical objects (e.g., the sofa 102, the loveseat 104, and the coffee table 106) in the environment 100 that are detected by the data capture device 108. In some embodiments, the mesh anchors have associated mesh geometry. The mesh geometry is a mesh, for example a triangle mesh, that represents physical objects (e.g., the sofa 102, the loveseat 104, and the coffee table 106) in the environment 100 that are detected by the data capture device 108. The mesh geometry can include vertices that, for example, define triangles. In some embodiments, the depth data can include an associated confidence map. The confidence map conveys the confidence in the accuracy of the depth data. Natural light of the environment 100 can affect the depth data such that the depth sensor may have low confidence about the accuracy of the depth data for surfaces that are highly reflective (e.g., mirrors) or have high light absorption (e.g., dark surfaces). The confidence map measures the accuracy of the depth data by including a confidence value for each component (e.g., mesh anchor, mesh geometry, vertices, etc.) of the depth data. Each component of the depth data includes a corresponding depth value, and each depth value has an associated confidence value. The depth value conveys the distance of the component from the depth sensor, and the confidence value associated with the depth value conveys the accuracy of the distance of the component from the depth sensor.

The data capture device 108 processes 204 data. In some embodiments, a device external to the data capture device 108 (sometimes referred to as “external device”) processes 204 images. The data capture device 108 or the external device includes one or more processing units such as, for example, central processing units (CPUs), graphics processing units (GPUs), and the like. The data capture device 108 or the external device can process 204 data utilizing one or more CPUs, one or more GPUs, or both. In some embodiments, it may be more efficient to process 204 data utilizing the GPUs rather than the CPUs, or a combination of the CPUs and the GPUs. The GPUs can include one or more shaders such as, for example, vertex shaders, fragment shaders, and the like. The vertex shaders determine locations of vertices of the mesh geometry. The fragment shaders determine colors to apply to the mesh geometry, for example to the vertices.

In some embodiments, the data capture device 108 or the external device can process the depth data to generate a smooth version of the depth data, for example by removing noise from the depth data. In some embodiments, noise is a mesh vertex having a depth value in excess of its neighbors. In some embodiments, noisy mesh vertices are moved by a vertex shader to place the respective noisy mesh vertex in a position such that the resultant orientation of its mesh triangle substantially aligns with neighboring mesh triangles (to include positive and negative angular alignment). In some embodiments, a mask generated to represent and overlay the mesh geometry is given a depth or thickness value to accommodate for the variable mesh vertices' height. In some embodiments, a fragment shader generates an offset value in addition to a color value, the offset value greater than the vertex height change of the associated mesh triangle.

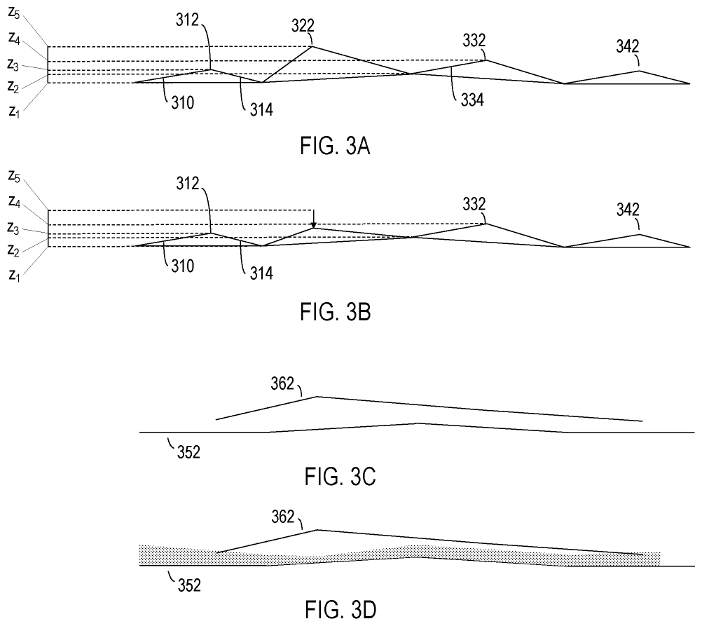

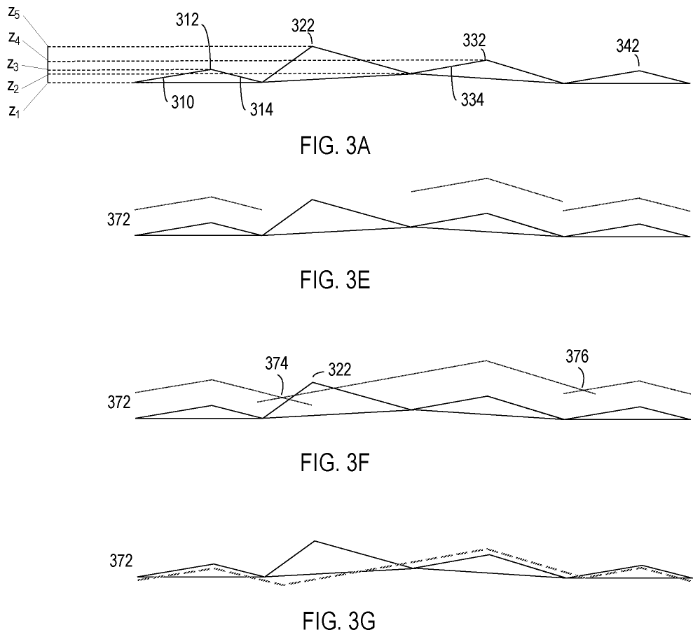

FIG. 3A illustrates a profile view of a mesh surface. While this profile view is illustrated as a series of triangles, these are indicative of surface relief and texture (e.g. profile surface ridge lines 310 and 314 project into and out of the plane as part of their respective mesh triangle faces, and point 312 is a vertex where mesh triangles intersect). In the illustrative example of FIG. 3A, the peaks and valleys of the surface profile may be mapped as a series of height profiles, z₁ through z_{N} with a selection from FIG. 3A depicted as z₁ through z₅ for the associated mesh geometries.

In some embodiments, a vertex shader adjusts noisy vertices by moving vertices that fall outside a gradient change of neighboring vertices. For example, for vertex 322 neighboring vertex 312 and 332 have height profiles z₃ and z₄ respectively. Vertex 322 with a height profile z₅ is outside the gradient change between neighboring vertices. In some embodiments, the vertex shader adjusts vertex 322 to a position within the gradient change (between z₃ and z₄) as depicted in FIG. 3B; in some embodiments, to reduce overfitting, the vertex shader incrementally moves vertex 322 towards the gradient change region between z₃ and z₄. At the end of each incremental change for all vertices of the mesh, the vertex shader repeats the adjustment process. In some embodiments, each global incremental pass increases the confidence value of the resultant mesh.

In some embodiments, the vertex shader moves noisy mesh vertices relative to neighboring triangle peak to valley values. Again looking to vertex 322 of FIG. 3A, in some embodiments a relative height may be a ratio of a peak to valleys, defined for vertex 322 as (z₅−z₁) and (z₅−z₂), with those neighboring triangles as represented by lines 314 and 334. In some embodiments, vertex height profile z₅ may be adjusted according to a smallest peak to valley ratio of neighboring triangles. For example, the smallest ratio is the lesser of (z₅−z₁)/(z₃−z₁) and (z₅−z₂)/(z₄−z₁), and the vertex is moved to a height that imposes that same constraint on the larger of the two ratios compared.

In some embodiments, a mask layer is created with a thickness or depth value based on the peak to valley variation among the underlying triangles and their neighbors. When a peak to valley value decreases, the mask depth thickness correspondingly increases. FIG. 3C depicts a line 362 representing a line connecting the vertex peak heights as from FIG. 3A, with line 352 representing the profile line of valley heights. In some embodiments, a smoothing mask layer is applied to the mesh, the smoothing mask layer having a variable thickness to accommodate the changes between peak and valley distances across the profile. FIG. 3D illustrates such smoothing mask layer, anchored to the valley height parameters though anchoring to another height parameter may be selected. In some embodiments, the rate of change for a smoothing mask layer thickness is the inverse of the profile height gradient; in some embodiments, the rate of change for a smoothing mask layer thickness is a multiple of the inverse of the profile height gradient.

In some embodiments, the smoothing mask layer generated as artificial triangles having an offset value from the respective triangle. In some embodiments, the offset value is equal to a multiple, e.g. 2×, the peak to valley value of the sampled mesh and the artificial triangles are dilated to intersect and generate a coherent artificial mesh and then positioned relative to the original mesh. In some embodiments, not every triangle is sampled. Mesh geometries within a sample producing a highest profile height do not have offset surfaces generated. FIG. 3E illustrates generated artificial mesh profile 372 having an offset value of 2× the peak to valley average of the sampled mesh, with FIG. 3F illustrating dilation of select offset artificial triangle surfaces to form new intersections among the geometry. In some embodiments, if the resulting artificial triangle mesh at the offset position has valley surface heights greater than the peak of the highest profile height vertices in the sample, a smaller multiple is applied and the process is repeated. For example, artificial mesh valleys 374 and 376 have lower profile heights than vertex 322, and the 2× offset multiple is acceptable for this smoothing mask layer. In FIG. 3G, the smoothing mask layer is positioned according to a least mean squares fitting to the original mesh according to the corresponding vertices (e.g. peaks) between the original geometry and the smoothing mask layer. By such techniques, a noisy mesh geometry or spurious triangles can be mitigated, removed, or otherwise processed to produce a more coherent underlying mesh for graphics passes.

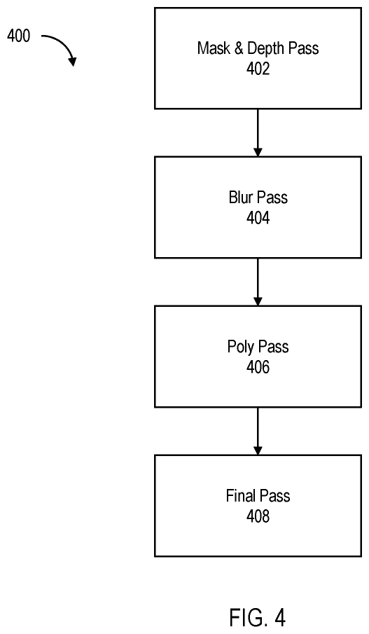

In some embodiments, the data capture device 108 or the external device can process the depth data to generate the smooth version of the depth data before the processing units of the data capture device 108 or of the external device execute render commands as described in relation to FIG. 4. In some embodiments, the data capture device 108 or the external device can process the depth data to generate the smooth version of the depth data while the processing units of the data capture device 108 or of the external device execute render commands as described in relation to FIG. 4, for example during a mask and depth pass 402 or a blur pass 404.

The processing units receive or access data (e.g., the visual data, the depth data, or both) captured 202 by the data capture device 108, and process 204 the data. Processing 204 the data can include augmenting the data. For example, the processing units can augment the visual data based on the depth data. The processing units can generate augmented visual data for display.

The data capture device 108 displays 206 visual data, such as augmented visual data. In some embodiments, an external device displays 206 visual data. In some embodiments, the data capture device 108 or the external device displays 206 the visual data captured by the data capture device 108. In some embodiments, the data capture device 108 or the external device displays 206 augmented visual data generated by the processing units. The data capture device 108 or the external device external can display 206 the visual data on a display. The display can be a liquid crystal display (LCD) (e.g., thin-film-transistor (TFT) LCD, in-panel-switching (IPS) LCD, capacitive touchscreen LCD, etc.), light-emitting-diode (LED) (e.g., organic LED (OLED), active matrix OLED (AMOLED), Super AMOLED, etc.), and the like.

In some embodiments, the data capture device 108 captures 202 the data, and an external device processes 204 the data for display 206 on the data capture device 108. In some embodiments, the data capture device 108 captures 202 the data, and an external device processes 204 the data for display 206 on an external device, for example either on the same external device that processed 204 the data or a separate external device.

### Multi-Pass Processing Pipeline

In some embodiments, the data captured by the data capture device 108 can be evaluated or modified using a multi-pass processing pipeline, for example with depth propagation. The processing units of the data capture device 108 or of an external device process 204 data captured 202 by the data capture device 108 to generate augmented data such as augmented visual data for display 206 on the data capture device 108 or on an external device. The processing units process 204 data by executing one or more render commands. When a render command is executed, one or more layers (sometimes referred to as “render layers”) or passes (sometimes referred to as “render passes”) of a render group are executed which generate outputs that are combined or composited to generate augmented or combined data such as augmented visual data. In some embodiments, rendering in layers can include separating different objects into separate data layers, and rendering in passes can include separating out or segmenting different aspects of the scene. The following is described in relation to passes, but the teachings can be applied to layers. A render command can include instructions for executing one or more passes. The output of a pass is visual data or a map that is stored in a buffer (e.g., a framebuffer) in memory that is input to or accessible by one or more other passes or the display.

FIG. 4 illustrates a render group 400, according to some embodiments. The render group includes a mask and depth pass 402, a blur pass 404, a poly pass 406 (sometimes referred to as a “polygon pass 406”), and a final pass 408 (sometimes referred to as a “combination pass 408”). The render group 400 can include additional or fewer passes. In some embodiments, the mask and depth pass 402 can be separate passes (i.e., a mask pass and a depth pass). In some embodiments, the mask and depth pass 402, the blur pass 404, the poly pass 406, and the final pass 408 can be a single pass. In some embodiments, the blur pass 404 and the poly pass 406 are optional passes.

Each pass of the render group 400 is executed in series, in parallel, or some combination thereof. The processing units can utilize one or more shaders when executing a pass.

The frequency at which the processing units execute the render command can be fixed (i.e., static) (e.g., 30 Hz, 24 Hz, etc.) or dynamic. A dynamic frequency can aid in balancing performance (e.g., of the processing units, etc.), resources (e.g., the processing units, memory, etc.), and power consumption (e.g., of the components of the data capture device 108). In embodiments where the frequency is dynamic, the processing units can execute the render command based on a capture rate of the data, a refresh rate of the display, a rate of change of the pose of the data capture device 108, or some combination thereof. In some embodiments, the processing units can execute the render command at the same rate as the capture rate of the data, the refresh rate of the display, or the rate of change of the pose of the data capture device 108. In some embodiments, the processing units can execute the render command at a rate that is a multiple (e.g., twice, half, etc.) of the capture rate of the data, the refresh rate of the display, or the rate of change of the pose of the data capture device 108. The capture rate of the data is the rate at which data is captured by the data capture device 108. The capture rate of the data can include a visual data capture rate which is the rate at which visual data is captured by the data capture device 108, and a depth data capture rate which is the rate at which depth data is captured by the data capture device 108. The capture rate of the data can be static or dynamic. A dynamic capture rate can be based on the environment 100 (e.g., whether the scene is static or not static) or the rate of change of the pose of the data capture device 108. Examples of capture rates include 10 Hz, 24 Hz, 30 Hz, 60 Hz, 120 Hz, and the like. The refresh rate of the display is the rate at which content is displayed. The refresh rate of the display can be static or dynamic. A dynamic refresh rate can be based on the render command execution rate, the capture rate of the data, or the rate of change of the pose of the data capture device 108. Examples of refresh rates of the display include 10 Hz, 24 Hz, 30 Hz, 60 Hz, 120 Hz, and the like. The rate of change of the pose of the data capture device 108 can be calculated from sensor data of one or more sensors, such as, for example, accelerometers, inertial measurement units (IMUs), altimeters, gyroscopes, magnetometers, light sensors, and the like. In some examples, when the capture rate of the data is low (e.g., when the scene is static), the processing units can execute the render command at a low rate (e.g., 12 Hz), and when the capture rate of the data is high (e.g., when the scene is not static), the processing units can execute the render command at a high rate (120 Hz). In some examples, when the rate of change of the pose of the data capture device 108 is low (e.g., when the data capture device 108 is moving slowly), the processing units can execute the render command at a low rate (e.g., 12 Hz), and when the rate of change of the pose of the data capture device is high (e.g., when the data capture device 108 is moving quickly), the processing units can execute the render command at a high rate (e.g., 120 Hz).

In the mask and depth pass 402, the processing units receive or access visual data, depth data including mesh anchors and mesh geometry, or both, generate one or more masks based on the mesh anchors and the mesh geometry, and generate a depth propagation based on the masks. The output of the mask and depth pass 402 is one or more masks, a depth propagation, or both, that are stored as visual data (e.g., one or more images), depth data, one or more maps, or both. The output of the mask and depth pass 402 can be stored in a database.

The visual data, the depth data including the mesh anchors and the mesh geometry, or both can be stored in a database. In some embodiments, the processing units receive or access visual data, depth data including mesh anchors and mesh geometry, or both, related to the loveseat 104 and parts of the coffee table 106 captured by the data capture device 108 with the previous pose 110, and visual data, depth data including mesh anchors and mesh geometry, both, related to the sofa 102 and parts of the coffee table 106 captured by the data capture device 108 with the current pose 112.

In some embodiments, the processing units generate depth data including generated mesh anchors and generated mesh geometry related to simulated holes, sometimes referred to as missing data. As used herein, simulated holes describe incomplete portions of a current scan (e.g., before a reconstruction process) whereas traditional holes describe incomplete portions of a completed scan (e.g., after a reconstruction process). In other words, the generated depth data including the generated mesh anchors and the generated mesh geometry related to the simulated holes represent the occurrence of potential undetected data by the data capture device 108 (i.e., occluded objects or portions). In some embodiments, the captured depth data including the captured mesh anchors and the captured mesh geometry describes what is captured in the environment 100, and the generated depth data including the generated mesh anchors and the generated mesh geometry describes that which is not captured in the environment 100. In other words, a scan or data capture of environment 100 is represented by the captured depth data and the generated depth data. In some examples, depth data can be captured for objects or areas in the environment 100 that are captured by the data capture device 108 (captured depth data), and depth data can be generated for objects or areas in the environment 100 that are not captured by the data capture device 108 (generated depth data).

The captured depth data can correspond to objects or areas in the environment 100 that are captured by the data capture device 108. The objects or areas in the environment 100 that are captured by the data capture device 108 may occlude objects or areas, for example objects or areas that are behind them relative to the pose(s) of the data capture device 108. The generated depth data can correspond to occluded objects or areas that are occluded by the captured objects or areas (i.e., the objects or areas that the captured objects or areas occlude). The generated depth data can be geometry, for example planar geometry, that extends from the captured objects or areas into occluded objects or areas.

In some embodiments, as the scan progresses, representations of generated depth data (e.g. displayed pixels, generate mesh anchors, or generated mesh geometry) are replaced with captured depth data. In some examples, data representing generated depth data comprises metadata designating it as unobserved; unobserved data is eligible for replacement by captured depth data when the data capture device 108 records geometry at the location of the generated depth data. In some embodiments the generated depth data including the generated mesh anchors and the generated mesh geometry related to the simulated holes can be updated as the scan progresses and the data capture device 108 detects more physical objects in the environment 100. For example, when the data capture device 108 has the previous pose 110, the generated depth data including the generated mesh anchors and the generated mesh geometry related to the simulated holes can include portions underneath the coffee table 106 that are not visible from the previous pose 110, and when the data capture device 108 has the current pose 112, the generated depth data including the generated mesh anchors and the generated mesh geometry related to the simulated holes can include portions underneath the coffee table 106 that are not visible from the current pose 112 and the previous pose 110. In this example, as the data capture device 108 transitions from the previous pose 110 to the current pose 112, the generated depth data including the generated mesh anchors and the generated mesh geometry related to the simulated holes can be updated, for example as more or different portions underneath the coffee table 106 become visible, thereby changing the generated depth data including the generated mesh anchors and the generated mesh geometry related to simulated holes to the captured depth data including the captured mesh anchors and the captured mesh geometry related to the physical objects in the environment 100, specifically the ground underneath portions of the coffee table 106 that is visible from the current pose 112 and the previous pose 110.

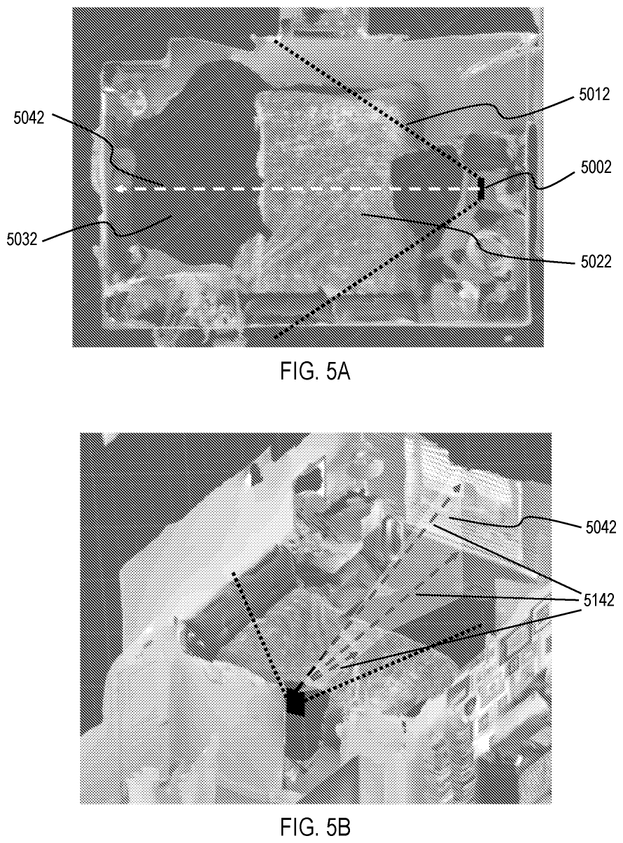

FIG. 5A depicts a top down view of a scanned environment, wherein data capture device 5002 performs depth scanning within its frustum 5012. Light of sight obstruction from bed 5022 creates unobserved data manifesting as hole 5032 in the scanned data. Depth scan line 5042 extends as a vertical plane from data capture device 5002 into the environment to detect depth of objects from the data capture device 5002.

FIG. 5B illustrates an oblique perspective view of the same environment as from FIG. 5A, and the planar nature of depth scan line 5042 from the sensor of data capture device 5002 (e.g. a LiDAR scanner). Representative light pulses 5142 are in line with vertical scan plane 5042 as they project from data capture device 5002 to scan the depth of the environment.

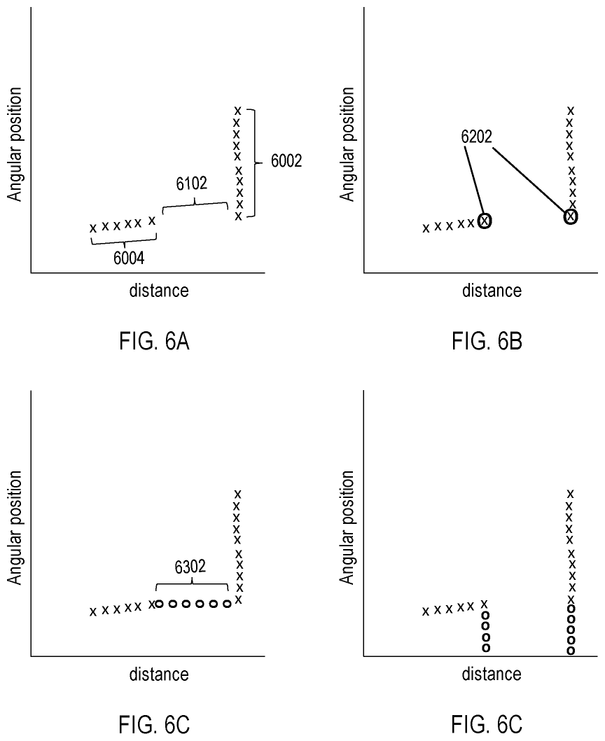

FIG. 6A represents an illustrative histogram of scanned depth within vertical scan plane 5042. Plotting group 6002 represents the scanned depth of the far wall, with plotting group 6004 representing the scanned depth of the bed. Due to the bed's line of sight obstruction with intervening objects and geometry, the depth data at the angular position for the bed's edge abruptly changes from grouping 6004 to grouping 6002. This abrupt change is depicted as depth anomaly 6102. In some embodiments, a depth anomaly is registered when a scanned area returns a change in depth at one or more scan lines greater than a multiple of the distance to the far scanned object. For example, in FIG. 6A, the far scanned object is the far wall represented by plotting group 6002; illustratively this distance is n meters from data capture device 5002 and a data anomaly is registered when depth changes of a multiple of n meters occurs. In some embodiments, the multiple is less than 1, such as one half of n, or one third of n, or one fourth of n, and beyond and inclusive of the specific multiples mentioned herein. Selection of a multiple is responsive to the environment and the distance of the far object, as the distance n increases, a multiple for registering a depth anomaly in a scan line correspondingly increases. In some embodiments, for interior environments, a multiple of one-third n is utilized.

In some embodiments, a registered depth anomaly is a simulated hole. In some embodiments, generated depth data for the distal points of the depth anomaly (i.e. the ends of actual captured depth data, shown as points 6202 in FIG. 6B) augments the capture depth data such as with RGB marker distinguishing it or other visual cues (depicted as the circles over the plotted x depth points of FIG. 6B). When aggregated with depth anomalies of adjacent scan lines, the cumulative generated depth data augmentations depict an outline of simulated hole in the scan, and indirectly provides feedback to adjust a camera position to observe objects and data within the simulated hole to replace the generated depth data with captured depth data. Similarly, as depicted in FIG. 6C, generated depth data can linearly connect plotting groups across depth anomalies (shown as the line of circles 6302 in FIG. 6C), and when aggregated depict a multidimensional simulated hole in the scan in the form of a plane. In some embodiments, generated depth data is projected vertically, according to a gravity vector of data capture device 5002, from the points when capture depth data transition into depth anomaly regions as depicted in FIG. 6D.

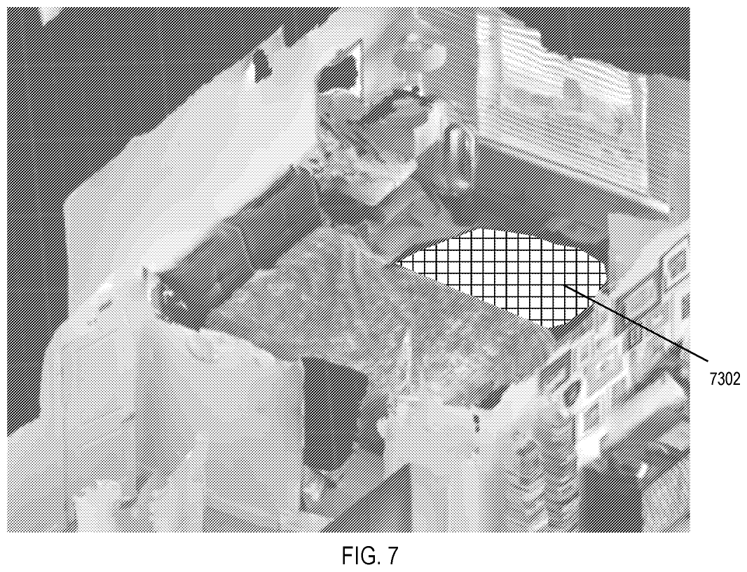

FIG. 7 depicts generated depth data 7302, built using the technique depicted in FIG. 6C and aggregating all simulated holes across the scan lines to produce a planar generated depth data, though such generated depth data may be extruded in other dimensions to create volumetric generated depth data. Generate depth data 7302 may persist in render space during a scan, and be replaced with captured data when data capture device 5002 observes objects within generated depth data 7302.

In some embodiments, a complete capture can be a capture where less than a predetermined threshold percentage (e.g., 5%) of total depth data of the environment, including captured depth data and generated depth data, corresponds to the generated depth data.

Generating the depth data including the generated mesh anchors and the generated mesh geometry related to the simulated holes can include determining the simulated holes based on the captured depth data including the captured mesh anchors and the captured mesh geometry related to the sofa 102, the loveseat 104, and the coffee table 106.

In some embodiments, registering the simulated holes can include determining where the captured depth data including the captured mesh anchors and the captured mesh geometry related to the sofa 102, the loveseat 104, and the coffee table 106 are, generating depth data including mesh anchors and mesh geometry for all other spaces, and associating metadata (e.g., a label) indicating the generated depth data including the generated mesh anchors and the generated mesh geometry are associated with simulated holes. For example, determining simulated holes can include determining where the captured depth data including the captured mesh anchors and the captured mesh geometry related to the sofa 102, the loveseat 104, and the coffee table 106 are, generating depth data including mesh anchors and mesh geometry for space underneath the sofa 102, the loveseat 104, and the coffee table 106, and associating metadata indicating the generated depth data including the generated mesh anchors and the generated mesh geometry are associated with simulated holes.

The processing units determine locations of the visual data, the depth data including the mesh anchors and the mesh geometry, or both. The location of the visual data, depth data including the mesh anchors and the mesh geometry, or both, can be relative to a world coordinate system, relative to an environment coordinate system, relative to a pose of the data capture device 108 at the start of a capture session, relative to the current pose 112 of the data capture device 108, etc.

The processing units determine the current time (i.e., time elapsed relative to a capture start time). The processing units determine times associated with the visual data, the depth data including the mesh anchors and the mesh geometry, or both, (i.e., when the visual data, the depth data including the mesh anchors and the mesh geometry, or both, were captured/created relative to the capture start time). The processing units can compare the current time with the times associated with the visual data, the depth data including the mesh anchors and the mesh geometry, or both. In some embodiments, an object can have multiple visual data (e.g., multiple images), multiple depth data including mesh anchors and mesh geometry, or both, associated with it, where each visual data (e.g., each image), each depth data including mesh anchors and mesh geometries, or both, has a time associated with it. In these embodiments, the processing units can choose the visual data, the depth data including the mesh anchors and the mesh geometry, or both, associated with the object that have an associated time that is closest to the current time (i.e., the most current visual data, depth data including mesh anchors and mesh geometry, or both).

In some embodiments, a mask can be a matrix of values. The mask can correspond to the visual data (e.g., image). For example, a pixel of the mask can correspond to a pixel of the visual data. The mask can correspond to the depth data including the mesh anchors and the mesh geometry. For example, a pixel of the mask can correspond to depth data including mesh anchors and mesh geometry, for example, from a perspective of the data capture device 108. In some embodiments, the mask can be a binary mask where each pixel is represented by a binary value, for example ‘0’ or ‘1’. In some embodiments, the mask is an n-ary mask where each pixel is represented by a value, for example between 0 and n−1, inclusive. The mask can be used to apply one or more effects to the visual data based on the values of the pixels of the mask. Examples of effects include blurring, colorizing, decolorizing, changing color, brightening, darkening, changing opacity/transparency, and the like.

In some embodiments, a mask can characterize corresponding visual data. For example, one or more pixels of a mask can characterize one or more corresponding pixels of corresponding visual data. In one specific non-limiting example, referring briefly to FIG. 1, the data capture device 108 with the current pose 112 can capture visual data of the environment 100, where the visual data includes the sofa 102 and the coffee table 106. A mask corresponding to the visual data is generated. The mask characterizes the corresponding visual data by “masking out” the coffee table 106. In this example, the mask can be a binary mask including a ‘1’ for each pixel of the mask that corresponds to the coffee table 106 in the visual data. The mask can be used to apply an effect to the coffee table 106, for example to blur the coffee table 106.

The processing units generate a first mask, sometimes referred to as a depth-contoured mask, based on the visual data, the depth data including the mesh anchors, the mesh geometry, or both, related to the physical objects in the environment 100 that are detected by the data capture device 108. In some embodiments, the first mask is a 2D representation of depth data including mesh anchors and mesh geometry related to the physical objects in the environment 100 that are detected by the data capture device 108. In some embodiments, the first mask enables depth data including mesh anchors and mesh geometry related to the physical objects in the environment 100 that are detected by the data capture device 108 to be referenced or modified, for example in the mask and depth pass 402 or in other passes. In some embodiments, the processing units can modify the first mask based on the generated depth data including the generated mesh anchors and the generated mesh geometry related to the simulated holes. In some embodiments, the modified first mask is a 2D representation of depth data including mesh anchors and mesh geometry related to the physical objects in the environment 100 that are detected by the data capture device 108 as well as depth data including mesh anchors and mesh geometry that represent the occurrence of potential undetected data by the data capture device 108 (i.e., occluded objects or portions).

In some embodiments, the processing units can generate a second mask, sometimes referred to as a simulated holes mask, based on the generated depth data including the generated mesh anchors and the generated mesh geometry related to simulated holes. In some embodiments, the second mask is a 2D representation of depth data including mesh anchors and mesh geometry that represent the occurrence of potential undetected data by the data capture device 108 (i.e., occluded objects or portions). In some embodiments, the second mask enables generated depth data including generated mesh anchors and generated mesh geometry related to the simulated holes to be referenced or modified, for example in the mask and depth pass 402 or in other passes. In some embodiments, the first mask and the second mask can be different masks.

In some embodiments, the processing units can generate or modify the first mask by applying a first color value (e.g., “painting”) to pixels of the visual data, the depth data including the mesh anchors and mesh geometry, or both, related to the physical objects in the environment 100 that are detected by the data capture device 108. In some embodiments, the processing units can generate or modify the first mask by applying a second color value to the generated depth data including the generated mesh anchors and the generated mesh geometry related to the simulated holes. In other words, the processing units can generate or modify the first mask by applying a second color value to generated depth data including generated mesh anchors and generated mesh geometry that represent the occurrence of potential undetected data by the data capture device 108 (i.e., occluded objects or portions). In some embodiments, the processing units can generate or modify the second mask by applying a second color value (e.g., “painting”) to the generated depth data including the generated mesh anchors and the generated mesh geometry related to the simulated holes. In other words, the processing units can generate or modify the second mask by applying a second color value to generated depth data including generated mesh anchors and generated mesh geometry that represent the occurrence of potential undetected data by the data capture device 108 (i.e., occluded objects or portions).

In some embodiments, a mask can include confidence values. For example, a mask intensity of a portion of a mask related to or associated with depth data, for example a mesh anchor or a mesh geometry, can be related to a confidence value of the depth data, for example the mesh anchor or the mesh geometry, for example, based on a confidence map associated with the mesh anchor or the mesh geometry.

In some embodiments, a color value intensity (e.g., brightness, opacity, color value on a spectrum, etc.) of a mesh anchor or a mesh geometry can be related to a confidence value of the mesh anchor or the mesh geometry, for example, based on a confidence map associated with the mesh anchor or the mesh geometry.

In some embodiments, a mask can convey (or cue) to a user of the data capture device 108 the visual data associated with the data but may not easily convey to the user the depth data associated with the data. In other words, the mask can aid the user in visualizing the captured data, but not easily aid the user in visualizing the extent (e.g., depth) of the captured data. One way to convey the extent (e.g., depth) of the captured data is by augmenting the mask. In some embodiments, augmenting the mask can include, for example, assigning or applying a color intensity value (e.g., brightness, opacity, color value on a spectrum, etc.) based on a depth value associated with the pixels of the visual data, the depth data including the mesh anchors and the mesh geometry, or both. In some embodiments, augmenting the mask can include, for example, making the mask dynamic (e.g., changing the mask over time). One way to make the mask dynamic can be by depth propagation, including depth perturbations, through the mask. One example of depth propagation is a wave, including wave perturbations. The depth propagation can be outward (e.g., radially) from the data capture device 108 with the current pose 112.

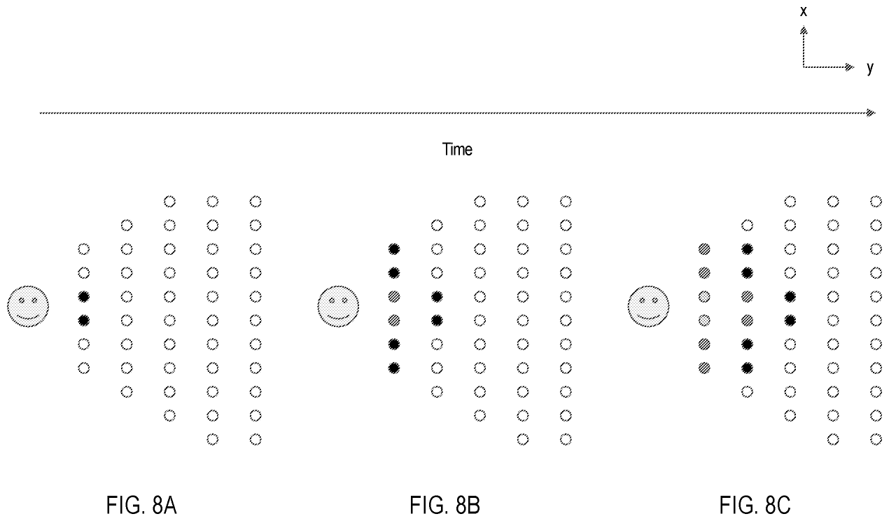

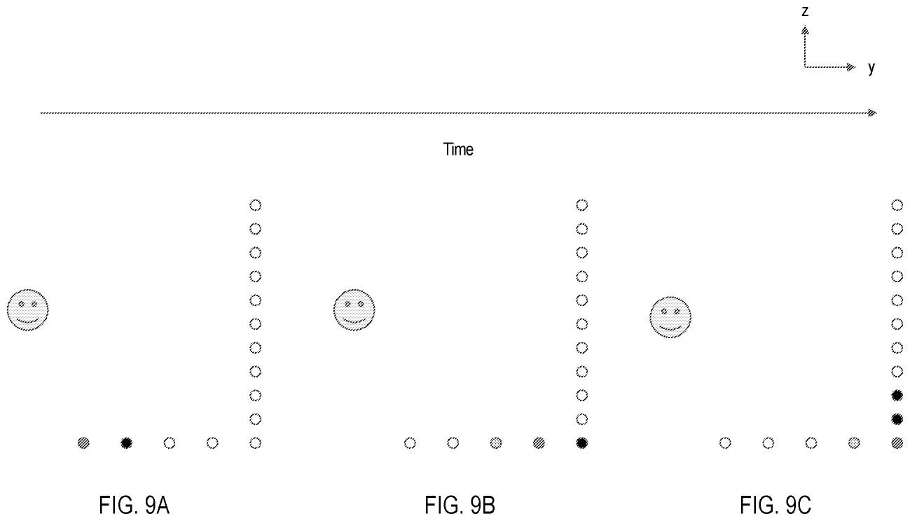

FIGS. 8A-8C illustrate a top-down (x-y plane) view of a depth propagation over time, according to some embodiments. For example, the top-down view of FIGS. 8A-8C can represent depth data including mesh anchors and mesh geometry associated with a floor of the environment 100. FIGS. 9A-9C illustrate a side (y-z plane) view of a depth propagation over time, according to some embodiments. For example, the side view of FIGS. 9A-9C can represent depth data including mesh anchors and mesh geometry associated with a floor and a wall of the environment 100. Specifically, FIGS. 9A-9C illustrate the intersection of the floor and the wall.

FIGS. 8A-8C and 9A-9C illustrate four types of circles: empty or white circles representing no depth propagation, black circles representing a leading edge of a depth propagation, and dark gray and light gray representing trailing aspects of the leading edge of the depth propagation.

The depth propagation can have one or more parameters or characteristics such as, for example, depth propagation location, depth propagation speed, depth propagation duration, depth propagation frequency, and the like. In some embodiments, the depth propagation can convey to the user of the data capture device 108 one or more information regarding the capture session, next steps to take during the capture session, and the like. For example, the depth propagation can convey to or influence the user of the data capture device 108 to speed up the movement of the data capture device 108 (e.g., increase the rate of change of the pose of the data capture device 108), to slow down the movement of the data capture device 108 (e.g., decrease the rate of change of the pose of the data capture device 108), that sufficient data (e.g., visual data, depth data including mesh anchors and mesh geometry, or both, related to the physical objects in the environment 100) has been or is being captured during the capture process, that sufficient data (e.g., visual data, depth data including mesh anchors and mesh geometry, or both, related to the physical objects in the environment 100) has not or is not being been captured during the capture process, etc. In some embodiments, the sufficient data can be related to the captured data and the simulated data. For example, the sufficient data can be a ratio of the captured data to the simulated data. Conveying to or influencing the user of the data capture device 108 during the capture process can impact the quality of the capture 202 of the images (i.e., the visual data, the depth data, or both). In one example, if the user is moving the data capture device 108 quickly, then sufficient data may not be captured or the data that is captured may be blurry, for example due to motion blur. In another example, if the user is moving the data capture device 108 slowly, portions of the environment may be captured too often which can result in more of the same data which can lead to longer uploading and processing times of the data.

The depth propagation location relative to the data capture device 108 is defined by the product of the depth propagation speed and the current time modulated by the depth propagation duration. Equation 1 is an example formula of the depth propagation location.

$$depth propagation location = depth propagation \text{} speed * ( current time \% depth propagation duration ) \qquad Equation 1$$

The depth propagation location is the location of the depth propagation from the data capture device 108 and may be expressed in meters. The depth propagation speed is the speed at which the depth propagation as propagates through the depth data and may be expressed in meters per second. The depth propagation duration is the amount of time the depth propagation propagates through the depth data before it repeats from the data capture device 108 and may be expressed in seconds.

Referring to FIGS. 8A-8C, they illustrate a top-down view a depth propagation over time. FIG. 8A illustrates the depth propagation at a first time, FIG. 8B illustrates the depth propagation at a second time after the first time, and FIG. 8C illustrates the depth propagation at a third time after the second time. The example illustrated in FIGS. 8A-8C can be a top-down view of a floor. As illustrated in FIGS. 8A-8C, the depth propagation can be outward (e.g., radially) from the data capture device 108 the user is holding.

Referring to FIGS. 9A-9C, they illustrate a side view of a depth propagation over time. FIG. 9A illustrates the depth propagation at a first time, FIG. 9B illustrates the depth propagation at a second time after the first time, and FIG. 9C illustrates the depth propagation at a third time after the second time. The example illustrated in FIGS. 9A-9C can be a side view of an intersection of a floor and a wall. As illustrated in FIGS. 9A-9C, the depth propagation can be outward (e.g., radially) from the data capture device 108 the user is holding. When the depth propagation on the floor in FIG. 9A reaches the intersection of the wall in FIG. 9B, instead of propagating the wall in one instance, the depth propagation gradually propagates up the wall in FIG. 9C.

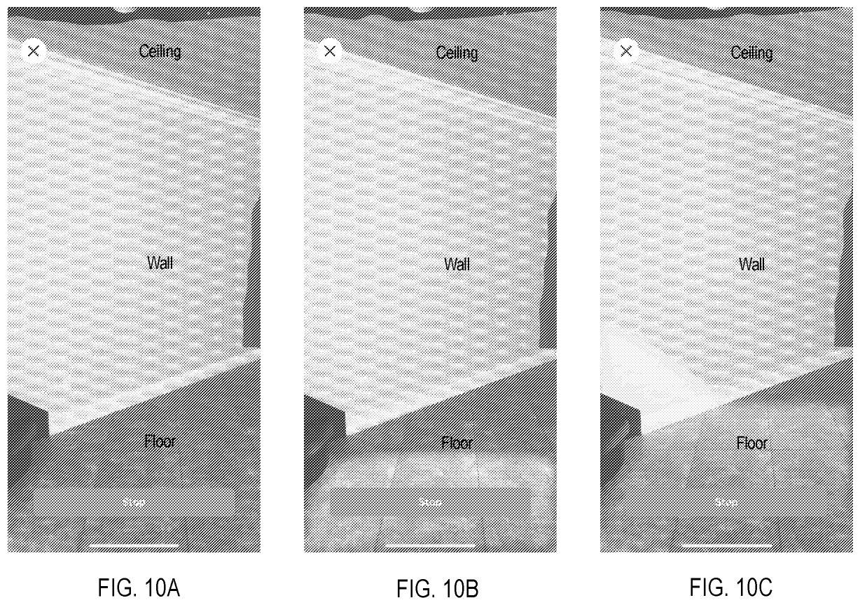

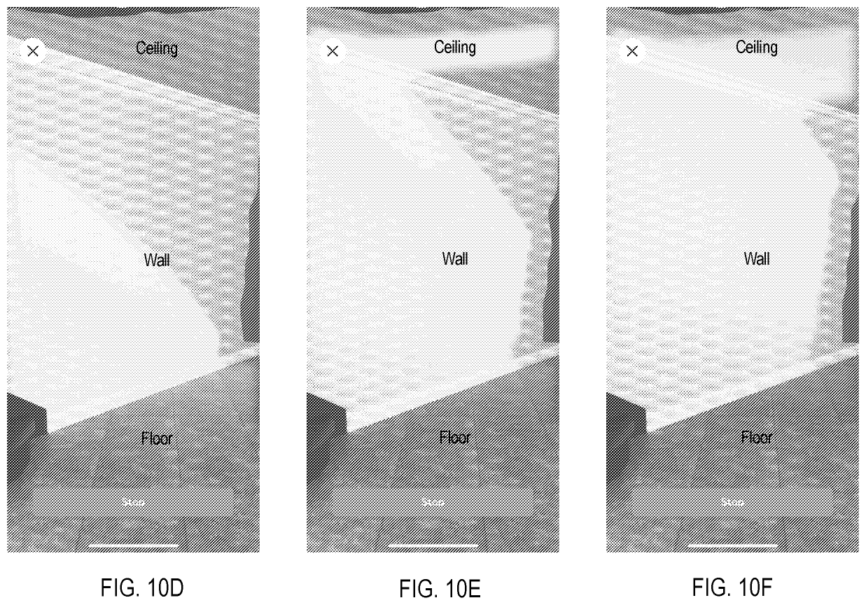

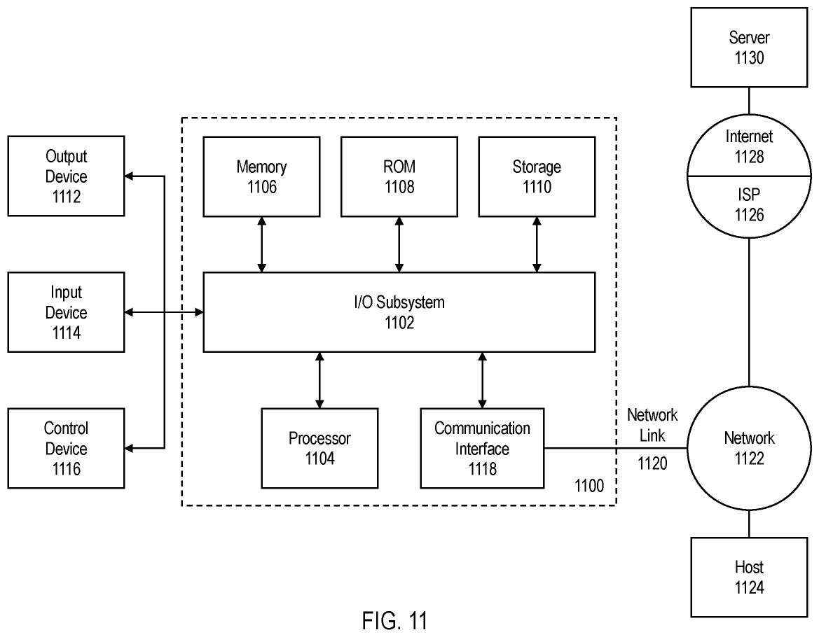

FIGS. 10A-10F illustrate graphical user interface element views including a depth propagation over time, according to some embodiments. For example, the view of FIGS. 10A-10F can represent depth data including mesh anchors and mesh geometry associated with a floor, wall, and ceiling of an environment. FIG. 10A illustrates no depth propagation, FIG. 10B illustrates depth propagation on the floor, FIGS. 10C-10D illustrate depth propagation on the floor and the wall, and FIGS. 10E-10F illustrate depth propagation on the floor, the wall, and the ceiling. FIG. 10A illustrates the depth propagation at a first time, FIG. 10B illustrates the depth propagation at a second time after the first time, FIG. 10C illustrates the depth propagation at a third time after the second time, FIG. 10D illustrates the depth propagation at a fourth time after the third time, FIG. 10E illustrates the depth propagation at a fifth time after the fourth time, and FIG. 10F illustrates the depth propagation at a sixth time after the fifth time. The example illustrated in FIGS. 10A-10F is a view of an intersection of the floor and the wall, and the wall and the ceiling. As illustrated in FIGS. 10A-10F, the depth propagation can be outward (e.g., radially) from a data capture device a user is holding. For example, FIGS. 10A-10F illustrate screenshots of graphical user interface element views of the data capture device. When the depth propagation on the floor in FIG. 10B reaches the intersection of the wall, instead of propagating the wall in one instance, the depth propagation gradually propagates up the wall in FIGS. 10C-10D. When the depth propagation on the wall propagation on the wall reaches the intersection of the ceiling, instead of propagating the ceiling in one instance, the depth propagation gradually propagates the ceiling in FIGS. 10E-10F.

In the blur pass 404, the processing units receive or access the output of the mask and depth pass 402 and generate a blurred version of the output of the mask and depth pass 402. The output of the blur pass 404 is a blurred mask, a blurred depth propagation, or both, that are stored as visual data (e.g., one or more images), one or more maps, or both.

The blurred mask can be used as a visual effect that, for example, reduces the perception of high frequency noise, reduces the perception of errors in the visual data, the depth data including the mesh anchors and the mesh geometry, or both, for the user of the data capture device 108.

The processing units can generate the blurred version of the output of the mask and depth pass 402 by blurring to the visual data, the map, or both, that is the output of the mask and depth pass 402. In some embodiments, the processing units can generate the blurred version of the output of the mask and depth pass 402 by applying a blur to the depth data including the mesh anchors and the mesh geometry underlying the mask, the depth propagation, or both that is the output of the mask and depth pass 402. Applying the blur to the depth data including the mesh anchors and the mesh geometry underlying the mask, the depth propagation, or both, can smooth out the depth data including the mesh anchors and the mesh geometry, resulting in, for example, depth data including mesh anchors and mesh geometry with fewer wave perturbations relative to the depth data including the mesh anchors and the mesh geometry of the underlying the mask, the depth propagation, or both. Blurring can include applying a Gaussian blur, a radial blur, a surface blur, or the like.

In some embodiments, if the visual data, the map, or both, or the depth data including the mesh anchors and the mesh geometry underlying the mask, the depth propagation, or both are not blurred, they may appear to have a lot of texture and may be perceived as having a large number features, and if they are too blurred, then they may appear to have very little texture and may be perceived as having a small number of features. In some embodiments, if the visual data, the map, or both, or the depth data including the mesh anchors and the mesh geometry underlying the mask, the depth propagation, or both are blurred an appropriate amount, they may appear to have an appropriate amount of texture and may be perceived as an appropriate number of features. In some embodiments, the appropriate amount of blurring can be established through a heuristic technique by adjusting the amount of blurring until the desired effect is achieved.

In some embodiments, different parts of the visual data, the map, or both, or the depth data including the mesh anchors and the mesh geometry underlying the mask, the depth propagation, or both can be blurred by varying degree. For example, parts of the visual data, the map, or both, or the depth data including the mesh anchors and the mesh geometry underlying the mask, the depth propagation, or both that correspond to a face of a person can be blurred more than the other aspects of the environment.

In some embodiments, the amount of blurring can be based on the rate of change of the pose of the data capture device 108. For example, a higher amount of blurring can be applied when the rate of change of the pose of the data capture device 108 is high than when the rate of change of the pose of the data capture device 108 is low. In some embodiments, the amount of blurring can be based on confidence values associated with the depth data. For example, a higher amount of blurring can be applied to depth data with low associated confidence values than depth data with high associated confidence values.

In the poly pass 406, the processing units receive or access the output of the blur pass 404 and generate a polygon version of the output of the blur pass 404. The output of the poly pass 406 is a poly mask, a poly depth propagation, or both, that are stored as visual data (e.g., one or more images), one or more maps, or both.

The processing units can generate the polygon version of the output of the blur pass 404 by applying a shading effect, such as a flat shading effect, to the visual data, the map, or both, that is the output of the blur pass 404. In some embodiments, the processing units can generate the polygon version of the output of the blur pass 404 by applying a shading effect to the depth data including the mesh anchors and the mesh geometry underlying the output of the blur pass 404. In some embodiments, applying the shading effect can include generating a virtual camera at a location of the data capture device 108, attaching a virtual light source to the virtual camera, and applying a shading technique, such as a flat shading technique, such that virtual light from the virtual light source reflects off of normals of the depth data including the mesh anchors and the mesh geometry. The shading effect can be used as a visual effect that, for example, simulates interactions of the visual data, the map, or both, that are the output of the blur pass 404, the depth data including the mesh anchors and the mesh geometry underlying the output of the blur pass 404, or a combination thereof, with a virtual light source to provide an immersive experience to the user of the data capture device 108. Applying the shading effect can enable the user of the data capture device 108 to view hard geometry (e.g., the mesh anchors and the mesh geometry). In some embodiments, applying the shading effect can convey to the user of the data capture device 108 that the environment 100 is being digitized.

In the final pass 408, the processing units receive or access the output of the poly pass 406 and current visual data and composites the output of the poly pass 406 and the current visual data to generate an augmented visual data.

FIG. 11 illustrates a computer system 1100 configured to perform any of the steps described herein. The computer system 1100 includes an input/output (I/O) Subsystem 1102 or other communication mechanism for communicating information, and a hardware processor, or multiple processors, 1104 coupled with the I/O Subsystem 1102 for processing information. The processor(s) 1104 may be, for example, one or more general purpose microprocessors.

The computer system 1100 also includes a main memory 1106, such as a random access memory (RAM), cache and/or other dynamic storage devices, coupled to the I/O Subsystem 1102 for storing information and instructions to be executed by processor 1104. The main memory 1106 also may be used for storing temporary variables or other intermediate information during execution of instructions to be executed by the processor 1104. Such instructions, when stored in storage media accessible to the processor 1104, render the computer system 1100 into a special purpose machine that is customized to perform the operations specified in the instructions.

The computer system 1100 further includes a read only memory (ROM) 1108 or other static storage device coupled to the I/O Subsystem 1102 for storing static information and instructions for the processor 1104. A storage device 1110, such as a magnetic disk, optical disk, or USB thumb drive (Flash drive), etc., is provided and coupled to the I/O Subsystem 1102 for storing information and instructions.

The computer system 1100 may be coupled via the I/O Subsystem 1102 to an output device 1112, such as a cathode ray tube (CRT) or LCD display (or touch screen), for displaying information to a user. An input device 1114, including alphanumeric and other keys, is coupled to the I/O Subsystem 1102 for communicating information and command selections to the processor 1104. Another type of user input device is control device 1116, such as a mouse, a trackball, or cursor direction keys for communicating direction information and command selections to the processor 1104 and for controlling cursor movement on the output device 1112. This input/control device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 1100 may include a user interface module to implement a GUI that may be stored in a mass storage device as computer executable program instructions that are executed by the computing device(s). The computer system 1100 may further, as described below, implement the techniques described herein using customized hard-wired logic, one or more ASICs or FPGAs, firmware and/or program logic which in combination with the computer system causes or programs the computer system 1100 to be a special-purpose machine. According to some embodiment, the techniques herein are performed by the computer system 1100 in response to the processor(s) 1104 executing one or more sequences of one or more computer readable program instructions contained in the main memory 1106. Such instructions may be read into the main memory 1106 from another storage medium, such as storage device 1110. Execution of the sequences of instructions contained in the main memory 1106 causes the processor(s) 1104 to perform the process steps described herein. In some embodiments, hard-wired circuitry may be used in place of or in combination with software instructions.

Various forms of computer readable storage media may be involved in carrying one or more sequences of one or more computer readable program instructions to the processor 1104 for execution. For example, the instructions may initially be carried on a magnetic disk or solid state drive of a remote computer. The remote computer can load the instructions into its dynamic memory and send the instructions over a telephone line, cable, using a modem (or optical network unit with respect to fiber). A modem local to the computer system 1100 can receive the data on the telephone line and use an infra-red transmitter to convert the data to an infra-red signal. An infra-red detector can receive the data carried in the infra-red signal and appropriate circuitry can place the data on the I/O Subsystem 1102. The I/O Subsystem 1102 carries the data to the main memory 1106, from which the processor 1104 retrieves and executes the instructions. The instructions received by the main memory 1106 may optionally be stored on the storage device 1110 either before or after execution by the processor 1104.

The computer system 1100 also includes a communication interface 1118 coupled to the I/O Subsystem 1102. The communication interface 1118 provides a two-way data communication coupling to a network link 1120 that is connected to a local network 1122. For example, the communication interface 1118 may be an integrated services digital network (ISDN) card, cable modem, satellite modem, or a modem to provide a data communication connection to a corresponding type of telephone line. As another example, the communication interface 1118 may be a local area network (LAN) card to provide a data communication connection to a compatible LAN (or WAN component to communicated with a WAN). Wireless links may also be implemented. In any such implementation, the communication interface 1118 sends and receives electrical, electromagnetic or optical signals that carry digital data streams representing various types of information.

The network link 1120 typically provides data communication through one or more networks to other data devices. For example, the network link 1120 may provide a connection through the local network 1122 to a host computer 1124 or to data equipment operated by an Internet Service Provider (ISP) 1126. The ISP 1126 in turn provides data communication services through the world-wide packet data communication network now commonly referred to as the “Internet” 1128. The local network 1122 and the Internet 1128 both use electrical, electromagnetic or optical signals that carry digital data streams. The signals through the various networks and the signals on the network link 1120 and through the communication interface 1118, which carry the digital data to and from the computer system 1100, are example forms of transmission media.

The computer system 1100 can send messages and receive data, including program code, through the network(s), the network link 1120 and the communication interface 1118. In the Internet example, a server 1130 might transmit a requested code for an application program through the Internet 1128, the ISP 1126, the local network 1122 and communication interface 1118.

The received code may be executed by the processor 1104 as it is received, and/or stored in the storage device 1110, or other non-volatile storage for later execution.

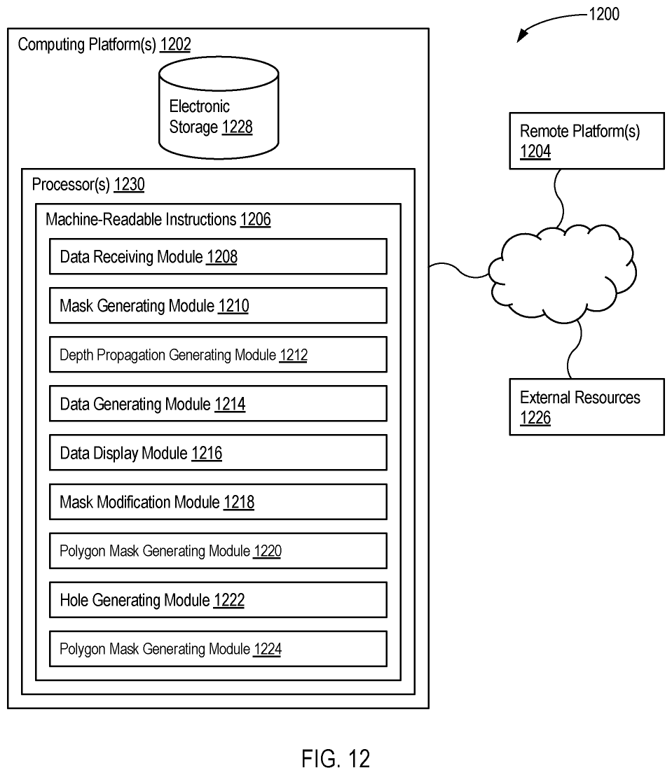

FIG. 12 illustrates a system 1200 configured for integrating disparate data streams of a current scan to generate visual cues of the current scan, in accordance with one or more implementations. In some implementations, system 1200 may include one or more computing platforms 1202. Computing platform(s) 1202 may be configured to communicate with one or more remote platforms 1204 according to a client/server architecture, a peer-to-peer architecture, and/or other architectures. Remote platform(s) 1204 may be configured to communicate with other remote platforms via computing platform(s) 1202 and/or according to a client/server architecture, a peer-to-peer architecture, and/or other architectures. Users may access system 1200 via remote platform(s) 1204.

Computing platform(s) 1202 may be configured by machine-readable instructions 1206. Machine-readable instructions 1206 may include one or more instruction modules. The instruction modules may include computer program modules. The instruction modules may include one or more of data receiving module 1208, mask generating module 1210, depth propagation generating module 1212, data generating module 1214, data display module 1216, mask modification module 1218, polygon mask generating module 1220, hole generating module 1222, polygon mask generating module 1224, and/or other instruction modules.

Data receiving module 1208 may be configured to receive, from a data capture device, captured visual data and captured depth data of a current scan of an environment. The captured visual data may include at least one of image data or video data. The captured depth data may include at least one of 3D point clouds, 3D line clouds, mesh anchors, or mesh geometry. By way of non-limiting example, the data capture device may be at least one of a smartphone, a tablet computer, an augmented reality headset, a virtual reality headset, a drone, or an aerial platform. The captured visual data and the captured depth data may include metadata. The metadata may include pose information of the data capture device. The environment may include at least one of an interior of a building structure or an exterior of the building structure. The captured depth data may include captured mesh anchors and captured mesh geometry.

Mask generating module 1210 may be configured to generate a first plurality of masks based on the captured depth data. The first plurality of masks correspond to one or more objects in the environment. The first plurality of masks may be a two-dimensional representation of the captured depth data.

The first plurality of masks may be modified. Mask modification module 1218 may modifying the first plurality of masks may be based on the captured depth data. Mask modification module 1218 may modifying the first plurality of masks may include applying a first color value to the first plurality of masks.

Generating the first plurality of masks may include generating first confidence values based on the captured depth data. Applying the first color value to the first plurality of masks may be based on the first confidence values.

Depth propagation generating module 1212 may be configured to generate a depth propagation based on the first plurality of masks. Generating, by the data generation module 1214, the depth propagation may be further based on the modified first plurality of masks. The depth propagation may include a plurality of parameters. By way of non-limiting example, the plurality of parameters may include depth propagation location, depth propagation speed, depth propagation duration, and depth propagation frequency. The depth propagation location may be a product of the depth propagation speed and the depth propagation duration modulated by a current time.

Data generating module 1214 may be configured to generate augmented visual data based on the captured visual data, the first plurality of masks, and the depth propagation. Generating the augmented visual data may include compositing the captured visual data, the first plurality of masks, and the depth propagation. Generating the augmented visual data may include generating a plurality of augmented masks based on the first plurality of masks. Generating the plurality of augmented masks may include applying a color intensity value to the first plurality of masks.

Mask generating module 1210 may be configured to generate a first plurality of blurred masks based on the first plurality of masks. Generating the first plurality of blurred masks may include applying a blur to the first plurality of masks. Depth propagation generating module 1212 may be configured to generate a blurred depth propagation based on the depth propagation. Generating the blurred depth propagation may include applying a blur to the depth propagation. Generating the augmented visual data may be further based on the first plurality of blurred masks and the blurred depth propagation. Generating the augmented visual data may include composting the captured visual data, the first plurality of blurred masks, and the blurred depth propagation.

Polygon mask generating module 1220 may be configured to generate a first plurality of polygon masks based on the first plurality of blurred masks. Depth propagation generating module 1212 may be configured to generate a polygon depth propagation based on the blurred depth propagation. Generating the augmented visual data may be further based on the first plurality of polygon masks and the polygon depth propagation. Generating the augmented visual data may include compositing the captured visual data, the first plurality of polygon masks, and the polygon depth propagation. Generating the first plurality of polygon masks may include applying a first shading effect to the first plurality of blurred masks. Generating the polygon depth propagation may include applying a second shading effect to the blurred depth propagation.

Data display module 1216 may be configured to display, on a display of the data capture device, the augmented visual data. The augmented visual data may be displayed during the current scan. The augmented visual data may be displayed during the current scan.

Hole generating module 1222 may be configured to generate depth data related to simulated holes of the current scan of the environment. The simulated holes may describe incomplete portions of the current scan. Generating depth data may be based on registering one or more depth anomalies in the captured depth data. The one or more depth anomalies may have a distance between captured depth data regions of a scan. The distance for the one or more depth anomalies may be a multiple of a distance from the data capture device to a furthest object in a depth pulse. The captured depth data may include captured mesh anchors and captured mesh geometry. The generated depth data may include generated mesh anchors and generated mesh geometry.

Mask generating module 1210 may be configured to generate a second plurality of masks based on the generated depth data. Generating the depth propagation may further be based on the second plurality of masks. The first plurality of masks correspond to one or more objects in the environment. The second plurality of masks correspond to one or more simulated holes of the current scan of the environment. The first plurality of masks and the second plurality of masks may include depth-contoured masks. The first plurality of masks may be a multi-dimensional representation of the captured depth data. The second plurality of masks may be a multi-dimensional representation of the generated depth data.

The first plurality of mask may be modified. The second plurality of masks may be modified. Generating the depth propagation may be further based on the modified first plurality of masks and the modified second plurality of masks. Mask modification module 1218 may modify the first plurality of masks. Modifying the first plurality of masks may be based on at least one of the captured depth data or the generated depth data. Modifying the first plurality of masks may include applying a first color value to the first plurality of masks. Generating the first plurality of masks may include generating first confidence values based on the generated captured data. Applying the first color value to the first plurality of masks may be based on the first confidence values. Mask modification module 1218 may modify the second plurality of masks. Modifying the second plurality of masks may be based on at least one of the captured depth data or the generated depth data. Modifying the second plurality of masks may include applying a second color value to the second plurality of masks. Generating the second plurality of masks may include generating second confidence values based on the generated depth data. Applying the second color value to the second plurality of masks may be based on the second confidence values.

Generating the augmented visual data may include compositing the captured visual data, the first plurality of masks, the second plurality of masks, and the depth propagation. Generating the augmented visual data may include generating a plurality of augmented masks based on the first plurality of masks and the second plurality of masks. Generating the plurality of augmented masks may include applying a first color intensity value to the first plurality of masks and applying a second color intensity value to the second plurality of masks.

Mask generating module 1210 may be configured to generate a first plurality of blurred masks based on the first plurality of masks. Mask generating module 1210 may be configured to generate a second plurality of blurred masks based on the second plurality of masks. Generating the blurred depth propagation may be based on the depth propagation. Generating the augmented visual data may be further based on the first plurality of blurred masks, the second plurality of blurred masks, and the blurred depth propagation. Generating the augmented visual data may include composting the captured visual data, the first plurality of blurred masks, the second plurality of blurred masks, and the blurred depth propagation. Generating the first plurality of blurred masks may include applying a blur to the first plurality of masks. Generating the second plurality of blurred masks may include applying a blur to the second plurality of masks. Generating the blurred depth propagation may include applying a blur to the depth propagation.

Polygon mask generating module 1224 may be configured to generate a first plurality of polygon masks based on the first plurality of blurred masks. Polygon mask generating module 1224 may be configured to generate a second plurality of polygon masks based on the second plurality of blurred masks. A polygon depth propagation may be generated based on the the blurred depth propagation. Generating the augmented visual data may be further based on the first plurality of polygon masks, the second plurality of polygon masks, and the polygon depth propagation. Generating the augmented visual data may include compositing the captured visual data, the first plurality of polygon masks, the second plurality of polygon masks, and the polygon depth propagation. Generating the first plurality of polygon masks may include applying a first shading effect to the first plurality of blurred masks. Generating the second plurality of polygon masks may include applying a second shading effect to the second plurality of blurred masks. Generating the polygon depth propagation may include applying a shading effect to the blurred depth propagation.

In some implementations, the generated depth data may include generated mesh anchors and generated mesh geometry.

In some implementations, computing platform(s) 1202, remote platform(s) 1204, and/or external resources 1226 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 1202, remote platform(s) 1204, and/or external resources 1226 may be operatively linked via some other communication media.

A given remote platform 1204 may include one or more processors configured to execute computer program modules. The computer program modules may be configured to enable an expert or user associated with the given remote platform 1204 to interface with system 1200 and/or external resources 1226, and/or provide other functionality attributed herein to remote platform(s) 1204. By way of non-limiting example, a given remote platform 1204 and/or a given computing platform 1202 may include one or more of a server, a desktop computer, a laptop computer, a handheld computer, a tablet computing platform, a NetBook, a Smartphone, a gaming console, and/or other computing platforms.

External resources 1226 may include sources of information outside of system 1200, external entities participating with system 1200, and/or other resources. In some implementations, some or all of the functionality attributed herein to external resources 1226 may be provided by resources included in system 1200.

Computing platform(s) 1202 may include electronic storage 1228, one or more processors 1230, and/or other components. Computing platform(s) 1202 may include communication lines, or ports to enable the exchange of information with a network and/or other computing platforms. Illustration of computing platform(s) 1202 in FIG. 12 is not intended to be limiting. Computing platform(s) 1202 may include a plurality of hardware, software, and/or firmware components operating together to provide the functionality attributed herein to computing platform(s) 1202. For example, computing platform(s) 1202 may be implemented by a cloud of computing platforms operating together as computing platform(s) 1202.

Electronic storage 1228 may comprise non-transitory storage media that electronically stores information. The electronic storage media of electronic storage 1228 may include one or both of system storage that is provided integrally (i.e., substantially non-removable) with computing platform(s) 1202 and/or removable storage that is removably connectable to computing platform(s) 1202 via, for example, a port (e.g., a USB port, a firewire port, etc.) or a drive (e.g., a disk drive, etc.). Electronic storage 1228 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 1228 may include one or more virtual storage resources (e.g., cloud storage, a virtual private network, and/or other virtual storage resources). Electronic storage 1228 may store software algorithms, information determined by processor(s) 1230, information received from computing platform(s) 1202, information received from remote platform(s) 1204, and/or other information that enables computing platform(s) 1202 to function as described herein.

Processor(s) 1230 may be configured to provide information processing capabilities in computing platform(s) 1202. As such, processor(s) 1230 may include one or more of a digital processor, an analog processor, a digital circuit designed to process information, an analog circuit designed to process information, a state machine, and/or other mechanisms for electronically processing information. Although processor(s) 1230 is shown in FIG. 12 as a single entity, this is for illustrative purposes only. In some implementations, processor(s) 1230 may include a plurality of processing units. These processing units may be physically located within the same device, or processor(s) 1230 may represent processing functionality of a plurality of devices operating in coordination. Processor(s) 1230 may be configured to execute modules 1208, 1210, 1212, 1214, 1216, 1218, 1220, 1222, and/or 1224, and/or other modules. Processor(s) 1230 may be configured to execute modules 1208, 1210, 1212, 1214, 1216, 1218, 1220, 1222, and/or 1224, and/or other modules by software; hardware; firmware; some combination of software, hardware, and/or firmware; and/or other mechanisms for configuring processing capabilities on processor(s) 1230. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 1208, 1210, 1212, 1214, 1216, 1218, 1220, 1222, and/or 1224 are illustrated in FIG. 12 as being implemented within a single processing unit, in implementations in which processor(s) 1230 includes multiple processing units, one or more of modules 1208, 1210, 1212, 1214, 1216, 1218, 1220, 1222, and/or 1224 may be implemented remotely from the other modules. The description of the functionality provided by the different modules 1208, 1210, 1212, 1214, 1216, 1218, 1220, 1222, and/or 1224 described below is for illustrative purposes, and is not intended to be limiting, as any of modules 1208, 1210, 1212, 1214, 1216, 1218, 1220, 1222, and/or 1224 may provide more or less functionality than is described. For example, one or more of modules 1208, 1210, 1212, 1214, 1216, 1218, 1220, 1222, and/or 1224 may be eliminated, and some or all of its functionality may be provided by other ones of modules 1208, 1210, 1212, 1214, 1216, 1218, 1220, 1222, and/or 1224. As another example, processor(s) 1230 may be configured to execute one or more additional modules that may perform some or all of the functionality attributed below to one of modules 1208, 1210, 1212, 1214, 1216, 1218, 1220, 1222, and/or 1224.

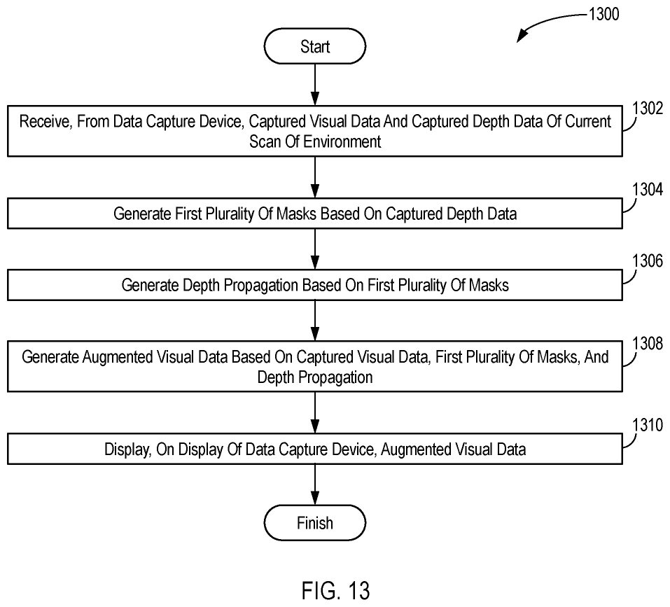

FIG. 13 illustrates a method 1300 for integrating disparate data streams of a current scan to generate visual cues of the current scan, in accordance with one or more implementations. The operations of method 1300 presented below are intended to be illustrative. In some implementations, method 1300 may be accomplished with one or more additional operations not described, and/or without one or more of the operations discussed. Additionally, the order in which the operations of method 1300 are illustrated in FIG. 13 and described below is not intended to be limiting.

In some implementations, method 1300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1300 in response to instructions stored electronically on an electronic storage medium. The one or more processing devices may include one or more devices configured through hardware, firmware, and/or software to be specifically designed for execution of one or more of the operations of method 1300.

An operation 1302 may include receiving, from a data capture device, captured visual data and captured depth data of a current scan of an environment. Operation 1302 may be performed by one or more hardware processors configured by machine-readable instructions including a module that is the same as or similar to data receiving module 1208, in accordance with one or more implementations.

An operation 1304 may include generating a first plurality of masks based on the captured depth data. Operation 1304 may be performed by one or more hardware processors configured by machine-readable instructions including a module that is the same as or similar to mask generating module 1210, in accordance with one or more implementations.

An operation 1306 may include generating a depth propagation based on the first plurality of masks. Operation 1306 may be performed by one or more hardware processors configured by machine-readable instructions including a module that is the same as or similar to depth propagation generating module 1212, in accordance with one or more implementations.

An operation 1308 may include generating augmented visual data based on the captured visual data, the first plurality of masks, and the depth propagation. Operation 1308 may be performed by one or more hardware processors configured by machine-readable instructions including a module that is the same as or similar to data generating module 1214, in accordance with one or more implementations.

An operation 1310 may include displaying, on a display of the data capture device, the augmented visual data. Operation 1310 may be performed by one or more hardware processors configured by machine-readable instructions including a module that is the same as or similar to data display module 1216, in accordance with one or more implementations.

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In some embodiments, a processor includes an FPGA or other programmable device that performs logic operations without processing computer-executable instructions. A processor can also be implemented as a combination of computing devices, for example, a combination of a DSP and a microprocessor, one or more microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

The technology as described herein may have also been described, at least in part, in terms of one or more embodiments, none of which is deemed exclusive to the other. Various configurations may omit, substitute, or add various procedures or components as appropriate. For instance, in alternative configurations, the methods may be performed in an order different from that described, or combined with other steps, or omitted altogether. This disclosure is further non-limiting and the examples and embodiments described herein does not limit the scope of the invention.

It should be emphasized that many variations and modifications may be made to the above-described embodiments, the elements of which are to be understood as being among other acceptable examples. All such modifications and variations are intended to be included herein within the scope of this disclosure.

1.-162. (canceled)

163. A method of integrating disparate data streams of a current scan to generate visual cues of the current scan, the method comprising:
receiving, from a data capture device, captured visual data and captured depth data of a current scan of an environment;
generating a first plurality of masks based on the captured depth data;
generating a depth propagation based on the first plurality of masks;
generating augmented visual data based on the captured visual data, the first plurality of masks, and the depth propagation; and
displaying, on a display of the data capture device, the augmented visual data.

164. The method of claim 163, wherein the environment comprises at least one of an interior of a building structure or an exterior of the building structure.

165. The method of claim 163, further comprising:
modifying the first plurality of masks; and
wherein generating the depth propagation is further based on the modified first plurality of masks.

166. The method of claim 165, wherein modifying the first plurality of masks comprises applying a first color value to the first plurality of masks.

167. The method of claim 166, wherein generating the first plurality of masks comprises generating first confidence values based on the captured depth data, and wherein applying the first color value to the first plurality of masks is based on the first confidence values.

168. The method of claim 163, wherein the depth propagation comprises a plurality of parameters, wherein the plurality of parameters comprises depth propagation location, depth propagation speed, depth propagation duration, and depth propagation frequency.

169. The method of claim 168, wherein the depth propagation location is a product of the depth propagation speed and the depth propagation duration modulated by a current time.

170. The method of claim 163, wherein generating the augmented visual data comprises compositing the captured visual data, the first plurality of masks, and the depth propagation.

171. The method of claim 163, wherein generating the augmented visual data comprises generating a plurality of augmented masks based on the first plurality of masks, and wherein generating the plurality of augmented masks comprises applying a color intensity value to the first plurality of masks.

172. The method of claim 163, further comprising:
generating a first plurality of blurred masks based on the first plurality of masks; and
generating a blurred depth propagation based on the depth propagation, and
wherein generating the augmented visual data is further based on the first plurality of blurred masks and the blurred depth propagation.

173. The method of claim 172, wherein generating the augmented visual data comprises composting the captured visual data, the first plurality of blurred masks, and the blurred depth propagation.

174. The method of claim 172, wherein generating the first plurality of blurred masks comprises applying a blur to the first plurality of masks, and wherein generating the blurred depth propagation comprises applying a blur to the depth propagation.

175. The method of claim 172, further comprising:
generating a first plurality of polygon masks based on the first plurality of blurred masks; and
generating a polygon depth propagation based on the blurred depth propagation, and
wherein generating the augmented visual data is further based on the first plurality of polygon masks and the polygon depth propagation.

176. The method of claim 175, wherein generating the augmented visual data comprises compositing the captured visual data, the first plurality of polygon masks, and the polygon depth propagation.

177. The method of claim 175, wherein generating the first plurality of polygon masks comprises applying a first shading effect to the first plurality of blurred masks, and wherein generating the polygon depth propagation comprises applying a second shading effect to the blurred depth propagation.

178. The method of claim 163, wherein the augmented visual data is displayed during the current scan.

179. The method of claim 163, further comprising:
generating depth data related to simulated holes of the current scan of the environment.

180. The method of claim 179, wherein generating depth data is based on registering one or more depth anomalies in the captured depth data.

181. A non-transient computer-readable storage medium having instructions embodied thereon, the instructions being executable by one or more processors to perform a method for integrating disparate data streams of a current scan to generate visual cues of the current scan, the method comprising:
receiving, from a data capture device, captured visual data and captured depth data of a current scan of an environment;
generating a first plurality of masks based on the captured depth data;
generating a depth propagation based on the first plurality of masks;
generating augmented visual data based on the captured visual data, the first plurality of masks, and the depth propagation; and
displaying, on a display of the data capture device, the augmented visual data.

182. A system configured for integrating disparate data streams of a current scan to generate visual cues of the current scan, the system comprising:
one or more hardware processors configured by machine-readable instructions to:
receive, from a data capture device, captured visual data and captured depth data of a current scan of an environment;
generate a first plurality of masks based on the captured depth data;
generate a depth propagation based on the first plurality of masks;
generate augmented visual data based on the captured visual data, the first plurality of masks, and the depth propagation; and
display, on a display of the data capture device, the augmented visual data.
